(19) United States
(12) Patent Application Publication
(10) Pub. No.: US 2008/0287340 A1
(43) Pub. Date: Nov. 20, 2008

(54) Water Softening Product

(75) Inventors: Fabio Corradini, Mira VE (IT); Emanuele Rossetto, Mira VE (IT)

Correspondence Address: NORRIS, MCLAUGHLIN & MARCUS, 875 THIRD AVE, 18TH FLOOR, NEW YORK, NY, 10022, US

(73) Assignee: Reckitt Benckiser N.V., WT Hoofddorp (NL)

(21) Appl. No.: 11/577,844

(22) PCT Filed: Oct. 10, 2005
(86) PCT No.: PCT/GB2005/003897

§ 371 Date: Oct. 9, 2007

(30) Foreign Application Priority Data
Oct. 29, 2004 (GB) 0424013.1

(51) Int. Cl. C11D 7/26; C11D 7/00

(52) U.S. Cl. 510/533; 510/531

(57) ABSTRACT

A water softening product having an enclosing wall and containing a composition in the form of a powder, said composition comprising a water-softening agent able to bind calcium ions, the wall being permeable to water and to components dissolved therein, wherein, after the product has been contacted with water in a ware washing machine, less than 20 wt % of the composition remains.

The present invention relates to a water softening product, in particular a water softening product having an enclosing wall and containing a composition in the form of a powder.

It is well known that certain metal compounds, notably calcium compounds, when present in water, have a significant effect on the properties in water. “Hard” water contains a significant loading of soluble calcium and magnesium compounds and forms a scum with soap or detergent, requiring a large amount of soap or detergent in order to form a lather. Scale deposits can readily form from such water, for example on heating, pH change or evaporation.

There have been many proposals for the removal of metal ions from aqueous solutions. In the industrial context proposals have included filter beds and polymeric filters for capturing heavy metal ions from an aqueous solution flowing within a passageway. Examples are given in EP-A-992,238 and GB-A-2,086,956. In the domestic context chelating compositions can be added to an aqueous washing solution to capture metal ions, such as calcium ions. Examples of chelating compositions are given in EP-A-892,040. However in a multi-step washing process, such as that carried out by a clothes washing machine, it can be a problem that the chelating agent is discharged, with the water, at an intermediate stage of the process.

Thus there is a need for a technology which can bind metal ions, at least calcium ions and preferably other metal ions in addition, in a convenient manner, through the entire course of a cleaning procedure, including the rinse cycle of a ware washing machine, in particular a clothes washing machine.

The present invention provides a water softening product having an enclosing wall and containing a composition in the form of a powder, said composition comprising a water-softening agent able to bind calcium ions, the wall being permeable to water and to components dissolved therein, wherein, after the product has been contacted with water in a ware washing machine, less than 20 wt % of the composition remains.

The water softening product of the present invention is designed such that the water softening agent is released over a period of time when exposed to water in the ware washing machine.

One advantage of the water softening products of the present invention is that discrete dosing is easily achieved and that the dosage may be varied without need of a measuring system, as would be required for a liquid or loose powder. If greater water softening is required more than one dose may be used at a time.

A further advantage of the water softening product of the present invention is that the consumer is provided with an immediate indication that the product has been used satisfactorily. The product, after it has been used, contains less than 20 wt % of the composition originally present. Thus both the visual and physical characteristics of the product noticeably change. In WO 03/054135 there is proposed a textile article having a water softening agent reversibly impregnated thereon. That product relies on a colour change to show that the product has been used effectively. This may not always be an entirely adequate indication to a consumer. For example, a colour change may be neutralised if a bleach is used. A colour change may also be disguised if strong colours run from clothes during a laundry process. Finally a colour change cannot be noticed by visually impaired people. In all of these instances the physical change of the water softening product of the present invention will still be apparent.

The water softening product of the present invention may be suitable for use in, for example, a dishwashing machine or a laundry washing machine.

The product has an enclosing wall which is permeable to water and to components dissolved therein. However, the wall is impermeable to the powder held within the product. The enclosing wall is permeable to water.

By water permeable we mean having an air permeability of at least 1000 l/m²/s at 100 Pa according to DIN EN ISO 9237. In addition the wall must not be so permeable that it is not able to hold the powder water softening composition. Thus, for example, the wall may have a mesh size of less than 250 microns, preferably less than 150 microns, more preferably less than 50 microns.

The closed product must resist a laundry wash cycle (2 h wash/rinse/spin cycle, 95° C., spinning at 1600 rpm) without opening.

The water softening composition is in the form of a powder. By “powder” we mean any solid, flowable composition. Thus the powder may, for example, be in the form of granules or agglomerated particles. The powder may not, however, be in the form of a tablet wherein the powder has been compressed. It may, however, be in the form of a loose agglomeration of particles. Preferably the average particle size is greater than 150, 200, 250, 350, 400, 500 microns.

The product should not be able to move out of the drum, such as by entering the internal piping of the washing machine and onto the filter. Thus it is generally large, preferably having a minimum length and width of at least 120 mm.

The product is preferably flat, i.e. the thickness of the sachet is at least 5 times less, preferably at least 10 times less, ideally at least 30 times less, than the other two dimensions, the width and the length, of the sachet.

The product could be discarded after use, or it could be regenerated when certain water-softening agents are used, for example cation exchange resins by using sodium chloride to effect ion exchange, and re-used.

The product may be placed with the items to be washed in an automatically washing machine. Alternatively the product may pack into the flow pathway for the rinse or wash water of a ware washing machine such that the water is compelled to flow through it. This is an efficient approach to softening the water used in clothes washing machines. Suitably the main wash water will not have flowed through the product, but softening thereof is effected by the conventional builders present in the laundry detergent composition. Prior to rinsing, the wash water containing the builders is drained away and only then is the rinse water delivered into the machine, this rinse water having been softened by flowing through the product located in the loading tray. Neither the builders nor the sequestrant in the product are active at the same time as the other. Thus, they do not compete with each other and are not used wastefully.

Preferably the product is formed into a flat container or a sachet from a sandwich of the two webs. A water permeable sheet or film is present in one of the webs, at least, and forms at least one wall of the container. The water-permeable outer wall may comprise, for example, a woven, knitted or preferably non-woven material, of textile, polymer or paper. The material may be in the form of single layer or laminated layers. Preferably the wall comprises a sheet with a ply of one, two or three layers, such that any non-dissolved or insoluble agent inside the container is too large to pass through the perforation(s) or must follow an impossible tortuous pathway if it were to exit the container through the wall. Preferably the sheet is a woven or non-woven material.

The product may conveniently comprise two webs sealed together about their periphery, with the contents held inside. The sealing may be by means of adhesive or dielectric welding or, preferably, heat sealing or, most preferably, ultrasound sealing. When the sealing is by heat sealing the sheets may comprise a thermoplastic to facilitate this. The material forming the adhesive strips can be a so called hot melt comprising various materials, such as APP, SBS, SEBS, SIS, EVA and the like, or a cold glue, such as a dispersion of various materials, e.g. SBS, natural rubber and the like, or even a solvent-based or a two-component adhesive system. Furthermore, the material may be capable of crosslinking to form specific, permanent chemical bonds with the various layers. The amount of adhesive is a function of the type of adhesive used. However it is generally from 0.2 to 20 g/m².

Conventional materials used in tea bag manufacture or in the manufacture of sanitary or diaper products may be suitable, and the techniques used in making tea bags or sanitary products can be applied to make flexible products useful in this invention. Such techniques are described in WO 98/36128, U.S. Pat. No. 6,093,474, EP-A-708,628 and EP-A-380,127.

Conveniently the two webs are non-wovens. Processes for manufacturing nonwoven fabrics can be grouped into four general categories leading to four main types of nonwoven products, textile-related, paper-related, extrusion-polymer processing related and hybrid combinations.

Textiles. Textile technologies include garneting, carding, and aerodynamic forming of fibres into selectively oriented webs. Fabrics produced by these systems are referred to as drylaid nonwovens, and they carry terms such as garneted, carded, and airlaid fabrics. Textile-based nonwoven fabrics, or fibre-network structures, are manufactured with machinery designed to manipulate textile fibres in the dry state. Also included in this category are structures formed with filament bundles or tow, and fabrics composed of staple fibres and stitching threads.

In general, textile-technology based processes provide maximum product versatility, since most textile fibres and bonding systems can be utilised.

Paper. Paper-based technologies include drylaid pulp and wetlaid (modified paper) systems designed to accommodate short synthetic fibers, as well as wood pulp fibres. Fabrics produced by these systems are referred to as drylaid pulp and wetlaid nonwovens. Paper-based nonwoven fabrics are manufactured with machinery designed to manipulate short fibres suspended in fluid.

Extrusions. Extrusions include spunbond, meltblown, and porous film systems. Fabrics produced by these systems are referred to individually as spunbonded, meltblown, and textured or apertured film nonwovens, or generically as polymer-laid nonwovens. Extrusion-based nonwovens are manufactured with machinery associated with polymer extrusion. In polymer-laid systems, fiber structures simultaneously are formed and manipulated.

Hybrids. Hybrids include fabric/sheet combining systems, combination systems, and composite systems. Combining systems employs lamination technology or at least one basic nonwoven web formation or consolidation technology to join two or more fabric substrates. Combination systems utilize at least one fabric substrate. Composite systems integrate two or more basic nonwoven web formation technologies to produce web structures. Hybrid processes combine technology advantages for specific applications.

Suitable materials for forming the enclosing wall are paper or a polyolefin, such as polyethylene or polypropylene, fibres.

Ideally the porosity of the material selected to prepare is greater than garnulemtry of the composition contained therein

The water softening product of the present invention is such that, after it has been contacted with water in a ware washing machine, less than 20 wt % of the composition remains. By this is meant that when the product is placed in the drum of a standard laundry washing machine, such as a Bosch WFR 3240 washing machine, at a standard washing cycle, in particular a cotton cycle at 60° C., and at any water hardness, but preferably at a water hardness of 18 to 24°dH (German degrees), less than 20 wt %, preferably less than 10 wt %, and most preferably less than 5 wt %, of the composition remains. Preferably a Bosch WFR 3240 laundry washing machine is used at a cotton cycle at 60° C. and at a water hardness of 18°dH. For the avoidance of doubt, even though this test uses a particular laundry washing machine, the water softening product of the present invention can be used in any laundry washing machine or other ware washing machine, such as a dishwashing machine, where water softening is desired. If the product meets the above test, it is capable of being used in any ware washing machine, even non-laundry machines.

The product contains a water softening agent which is capable of being washed away. Preferably the water softening agent is able to bind magnesium ions as well as calcium ions.

Preferably, water-soluble water softening agent is present in the powder composition in an amount of more than 1%, 5%, 10%, 20%, 30%, 40%, 50%, 60%, 70%, 80%, 90% and 95% wt. Desirable maximum amounts are less than 95%, 90%, 80%, 70%, 60%, 50%, 40%, 30%, 20% and 10% wt.

The water-soluble water softening agent is capable of being washed away from the product. By the term “water-soluble” we include agents that are water dispersible. Such agents include, for example, water-soluble polymers such as polycarbonates and polyacrylates. Examples of agents are:
1) Ion capture agents—agents which prevent metal ions from forming insoluble salts or reacting with surfactants, such as polyphosphate, monomeric polycarbonates, such as citric acid or salts thereof.
2) Anti-nucleating agents—agents which prevent seed crystal growth, such as polycarbonate polymers, such as polyacrylates, acrylic/maleic copolymers, phosphonates, and acrylic phosphonates and sulfonates.
3) Dispersing agents—agents that keep crystals suspended in solution, such as polyacrylate polymers.

The enclosing wall may be coated with a water-soluble component, such as a water-soluble polymer, for example a poly(vinyl alcohol).

The present invention also provides a method of softening hard water in a ware washing machine, for example a laundry or dish washing, wherein the hard water is contacted with a product as defined above.

The present invention is further described in the following Examples.

The following granular composition were prepared and 20 grams of each composition was placed between two sheets of a nonwoven polypropylene material, of approximately 10 cm². The edges of the two nonwoven sheets were heat sealed together to make a contiguous seal around the composition.

The porosity of the nonwoven sheet was selected such that it was smaller than average granulometry of the composition. Thus escape of the materials from the sealed nonwoven sachet was by dissolution only.

Composition 1

| | | Solubility | |
|---|---|---|---|
| Ingredients | Raw Materials | in water | |
| ACTIVES | Homopolymer | Soluble | 24.750 |
| | (polycarboxylate) | | |
| | Trisodium Citrate | Soluble | 52.730 |
| FILLER | Sodium Sulfate | Soluble | 23.52 |
| | TOTAL | | 100.000 |

Composition 2

| | | Solubility | |
|---|---|---|---|
| Ingredients | Raw Materials | in water | |
| ACTIVES | Homopolymer | Soluble | 24.750 |
| | (polycarboxylate) | | |
| | Trisodium Citrate | Soluble | 64.890 |
| DYE | Liquitint patent blue | Soluble | 0.016 |
| | (polymeric dye) | | |
| FILLER | Sodium Sulfate | Soluble | 20.344 |
| | TOTAL | | 100.000 |

Comparative Composition 1

| | | Solubility | |
|---|---|---|---|
| Ingredients | Raw Materials | in water | |
| ACTIVES | Homopolymer (polycarboxylate) | soluble | 35.000 |
| | Trisodium Citrate | soluble | 47.690 |
| | Layer Silicate | insoluble | 2.000 |
| ACTIVE | Zeolite | insoluble | 1.000 |
| DYE | Dye | soluble | 0.016 |
| FILLER | Sodium Bicarbonate | soluble | 15.294 |
| | TOTAL | | 100.000 |

1. A water softening product having an enclosing wall and containing a composition in the form of a powder, said composition comprising a water-softening agent able to bind calcium ions, the wall being permeable to water and to components dissolved therein, wherein, after the product has been contacted with water in a ware washing machine, less than 20 wt % of the composition remains.

2. A product according to claim 1 wherein after the product has been contacted with water less than 10 wt % of the composition remains.

3. A product according to claim 2 wherein after the product has been contacted with water less than 5 wt % of the composition remains.

4. A product according to claim 1 wherein the water-softening agent comprises a water-soluble polymer.

5. A product according to claim 4 wherein the water-soluble polymer is a polycarbonate or polyacrylate.

6. A product according to claim 1 wherein the water-softening agent comprises a polyphosphate, a monomeric polycarbonate or polycarboxylic acid or a mixture thereof.

7. A product according to claim 6 wherein the monomeric polycarbonate or polycarboxylic acid is citric acid or a salt thereof.

8. A product according to claim 1 wherein the enclosing wall comprises a water-permeable, water-insoluble web.

9. A product according to claim 8 wherein the web is a non-woven web.

10. A product according to claim 8 wherein the web is formed from polyolefin fibres.

11. A product according to claim 1 wherein the enclosing wall is coated with a water-soluble component.

12. A product according to claim 11 wherein the water soluble component comprises a poly(vinyl alcohol).

13. A method of softening hard water in a ware washing machine, comprising the steps of: contacting the hard with a product according to claim 1.

14. A product according to claim 2 wherein the water-softening agent comprises a water-soluble polymer.

15. A product according to claim 14 wherein the water-soluble polymer is a polycarbonate or polyacrylate.

16. A product according to claim 15 wherein the water-softening agent comprises a polyphosphate, a monomeric polycarbonate or polycarboxylic acid or a mixture thereof.

17. A product according to claim 16 wherein the monomeric polycarbonate or polycarboxylic acid is citric acid or a salt thereof.

18. A product according to claim 14 wherein the enclosing wall comprises a water-permeable, water-insoluble web.

19. A product according to claim 1 wherein the enclosing wall has an air permeability of at least 10001/m²/s at 100 Pa according to DIN EN ISO 9237.

20. A product according to claim 1 wherein the enclosing wall has a mesh size of less than 250 microns.
